(19) United States
(12) Patent Application Publication
(10) Pub. No.: US 2009/0270024 A1
(43) Pub. Date: Oct. 29, 2009

(54) Water-excluding air vent

(76) Inventor: Reid J. Buck, Virginia Beach, VA (US)

Correspondence Address: WILLIAMS G. SYKES, 3669 SEAGULL BLUFF DRIVE, VIRGINIA BEACH, VA, 23455, US

(21) Appl. No.: 12/150,143

(22) Filed: Apr. 25, 2008

(51) Int. Cl. F24F 13/08; B03B 13/00

(52) U.S. Cl. 454/283; 209/280

(57) ABSTRACT

A water-excluding vent structure wherein water impinging upon an outer surface thereof is excluded while air is allowed to freely flow through the vent structure to an internal space. The circular or other appropriate shaped vent structure has a series of parallel louvers designed for orientation in a level, horizontal plane. A porous, polypropylene membrane is placed behind the louvers. A perimeter gasket is used to seal the vent structure to the object to be ventilated. A notch is formed in an inner edge of the perimeter gasket along a line which is a perpendicular bisector of the louvers. The space defined by the notch is communicative with a drain hole in the outer housing. When properly oriented with the notch in a lowermost position, any moisture passing through the porous membrane collects in the notch and flows through the drain hole.

### FIELD OF THE INVENTION

The invention pertains to air vents for enclosed spaces and, more particularly, to a water-repelling air vent wherein moisture striking an internal vent membrane is directed outside the vented space.

### BACKGROUND OF THE INVENTION

Many enclosed structures require a vent to allow access to outside air. However, while numerous vent structures exist and are well known, no simple structures are known that provide a moisture barrier while allowing air to freely flow through. It is highly desirable to exclude moisture from many enclosed spaces. For example, a tool box may contain costly and/or delicate tools that may rust if moisture is allowed to enter the toolbox. Toolboxes designed without vents trap any moisture brought inside, perhaps on tools used in a moist or wet environment. A vented toolbox allows air circulation to remove moisture from within, thereby allowing even moist tools to dry.

Another type of enclosed space requiring ventilation is a below-deck compartment in a boat hull. By the very nature of a boat, water may frequently strike a vent structure, thereby forcing water into the ventilated space. This is disadvantageous for many obvious reasons.

### DISCUSSION OF THE RELATED ART

Many structures exist in the prior art to allow ventilating an enclosed space. For example, U.S. Pat. No. 1,400,562 for VENTILATOR, issued Dec. 20, 1921 to Theophilus M. Brown, teaches a vent structure having an internal labyrinth.

U.S. Pat. No. 2,480,562 for WATER EXCLUDING EVENT, issued Aug. 30, 1949 to J. M. Ewing, provides a vent structure with overlapping louvers.

U.S. Pat. No. 2,505,147 for VENTILATING DEVICE, issued Apr. 25, 1950 to Frank J. Scallon, shows a vent structure having an internal membrane coated with a heat-insulating material to prevent condensation thereupon.

U.S. Pat. No. 2,804,006 for VENTILATOR, issued Aug. 27, 1957 to Albert B. Shatkin, discloses a ventilator having a domed internal screen positioned behind louvers so as to exclude bugs.

U.S. Pat. No. 3,727,539 for FRESH AIR VENT, issued Apr. 17, 1973 to Fran Wilmes, teaches a vent structure designed to allow airflow at a controlled rate.

U.S. Pat. No. 3,892,169 for READILY INSTALLED VENT FOR FLEXIBLE COVER PANEL, issued Jul. 1, 1975 to Frank R. Jarnot, provides a vent structure for disposition about an opening provided for ventilation, and a flexible cover panel with the backing frame disposed against the inside surface of the cover panel.

U.S. Pat. No. 4,184,414 for FLEXIBLE COVER VENT, issued Jan. 22, 1980 to Frank R. Jarnot, shows a vent structure having first and second members with registered openings formed therethrough.

U.S. Pat. No. 5,201,879 for VENT FOR ENCLOSURES, issued Apr. 13, 1993 to Edward A. Steele, shows a vent arrangement for enclosures that prevents the entry of water into the enclosure.

U.S. Pat. No. 5,372,543 for VENT FOR ENCLOSURES, issued Dec. 13, 1994 to Edward A. Steele, teaches a vent structure that prevents the penetration of a pry bar.

U.S. Pat. No. 5,573,562 for WATERTIGHT FILTER FOR ELECTRICAL EQUIPMENT VENT, issued Nov. 12, 1996 to Erwin Schauwecker, shows a filter assembly for use on an enclosure having a vertical sidewall.

U.S. Pat. No. 5,782,051 for WATER RESISTANCE LOUVER, issued Jul. 21, 1998 to John F. LaVoie, shows a vent structure having an aluminum screen in front of a set of rear louvers.

U.S. Pat. No. 6,138,424 for VENT APPARATUS FOR ATTACHMENT TO A BUILDING STRUCTURE, issued Oct. 31, 2000 to Derek Parnell Ackerson; shows a vent structure with alternating louvers projecting from front and rear internal vertical surfaces.

U.S. Pat. No. 6,585,582 for VENT ATTACHMENT FOR A FLEXIBLE WALL, issued Jul. 1, 2003 to Peter W. Ziegler, provides a vent having an externally threaded nipple that is adapted to be received in a circular opening in a flexible wall.

None of the patents and published patent applications, taken singly, or in any combination are seen to teach or suggest the novel water-excluding vent structure of the present invention.

### SUMMARY OF THE INVENTION

In accordance with the present invention, there is provided a water-excluding vent structure wherein water impinging upon an outer surface thereof is excluded, while air is allowed to freely flow through the vent structure to an internal space requiring ventilation. The novel vent structure has a series of parallel louvers intended for orientation in a substantially horizontal plane.

A porous polypropylene membrane is disposed immediately behind the parallel louvers. A perimeter gasket is disposed behind the polypropylene membrane. An opening in the inner perimeter of the perimeter gasket allows any moisture droplets forming on the inside surface of the polypropylene membrane to be discharged through an orifice in the water-excluding vent structure.

In operation, impinging moisture passing through the louvers and the polypropylene membrane collects on the inner surface of the membrane, flows downward by gravitational attraction along the inner surface of the membrane, and is discharged through the orifice.

It is, therefore, an object of the invention to provide a water-excluding vent structure that effectively excludes moisture from an interior space to be ventilated.

It is another object of the invention to provide a water-excluding vent structure having a plurality of parallel louvers in a front surface thereof.

It is an additional object of the invention to provide a water-excluding vent structure having a porous membrane disposed on the inside surface of a plurality of parallel louvers.

It is a further object of the invention to provide a water-excluding vent structure having a perimeter gasket placed on a rear surface of the porous membrane.

It is a still further object of the invention to provide a water-excluding vent structure wherein an opening in an inner perimeter edge of a perimeter gasket collects moisture on an inside surface of the porous membrane, and directs the moisture to an orifice in the lower region of the vent structure.

It is yet another object of the invention to provide a water-excluding vent structure that is substantially circular or other appropriate shapes having a plurality of substantially parallel horizontal louvers.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1a is a front, elevational view of the water-excluding vent structure in accordance with the invention;

FIG. 1b is a side, elevational view of the water-excluding vent structure of FIG. 1a;

FIG. 2 is a front elevational view of a porous membrane for use with the water-excluding vent structure of FIG. 1;

FIG. 3 is a plan view of a perimeter gasket for use with the water-excluding vent structure of FIG. 1; and

FIG. 4 is an exploded, perspective view of the water-excluding vent of FIG. 1.

### DETAILED DESCRIPTION OF THE PREFERRED EMBODIMENT

The present invention provides a water-excluding vent structure for providing ventilation to an enclosed space.

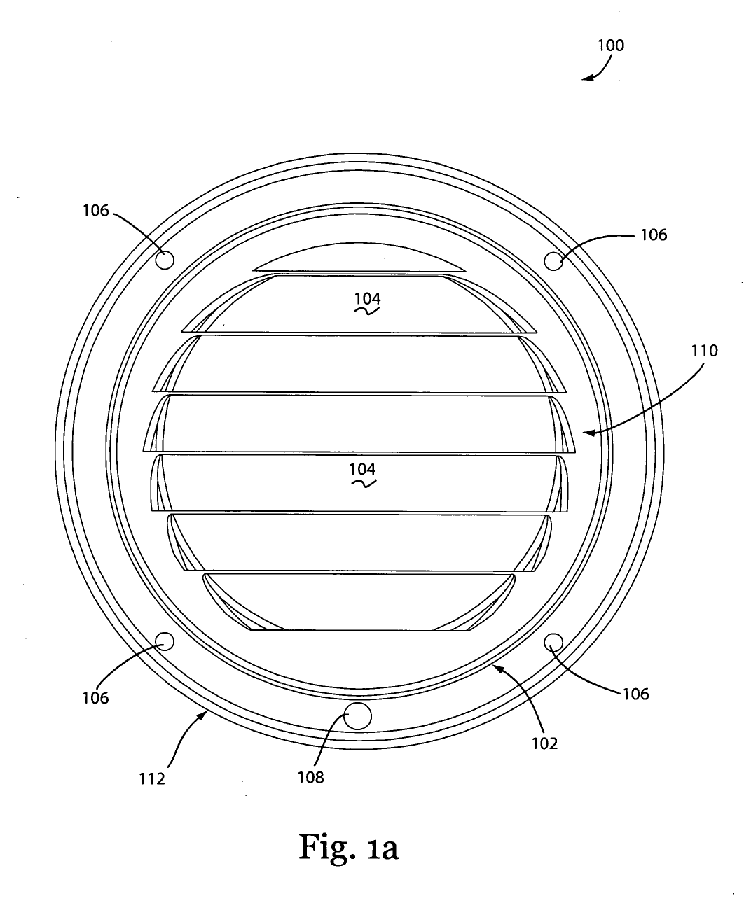

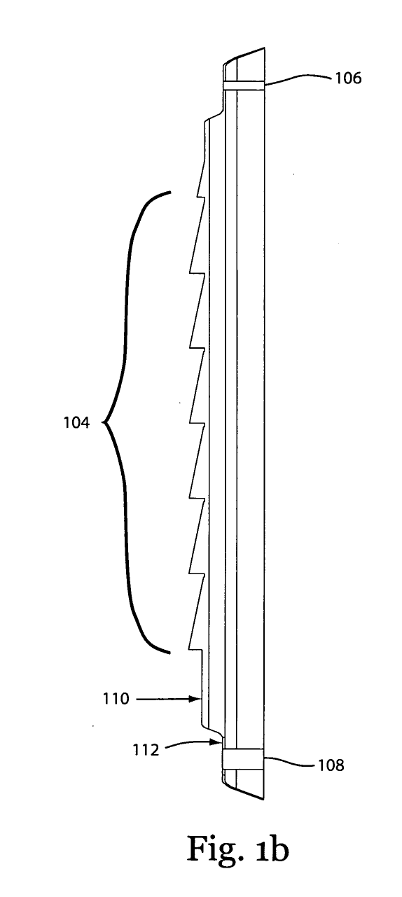

Referring first to FIG. 1a, there is shown a front, elevational view of a first embodiment of a water-excluding vent in accordance with the present invention, generally at reference number 100.

Water-excluding vent 100 is substantially circular in shape. It will, of course, be recognized that water-excluding vent 100 could be formed in other shapes. Consequently, the invention is not limited to the circular shape used for purposes of disclosure.

An outer housing 102 is formed from any suitable metallic or polymeric material. Outer housing 102 has a central, louver-receiving region 110 surrounded by a perimeter region 112. A series of substantially parallel louvers 104 are formed in the central, louver-receiving region 110 of outer housing 102.

Mounting holes 106, disposed in perimeter region 112, are provided for attaching water-excluding vent 100 to a surface, not shown, associated with the space to be ventilated. Screws, nails, or other similar fasteners, none of which are shown, may be used to attach water-excluding vent 100 to a surface as desired. While four mounting holes 106 are shown, it will be recognized that other numbers of mounting holes 106 may be substituted to meet a particular operating circumstance or environment. Consequently, the invention is not limited to a particular quantity of mounting holes 106. It will also be recognized that other attachment methods may be utilized that do not require mounting holes 106, and therefore, mounting holes 106 may, optionally, be eliminated.

A drain hole 108 is provided in a lowermost portion of outer housing 102. The term, “lowermost,” relates to the orientation of water-excluding vent 100 as depicted in FIG. 1.

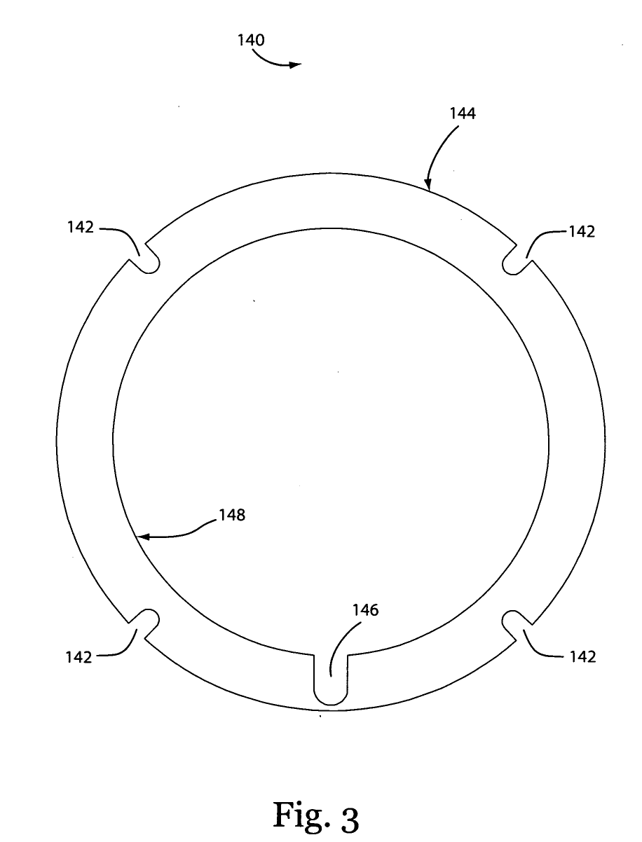

Referring now also to FIG. 1b, there is shown a side, elevational view of outer housing 102. As may be seen, louver-receiving region 110 may optionally be raised (i.e., exdented in a Z-axis perpendicular to louver-receiving region 110) with respect to perimeter region 112. This allows louvers 104 to readily be formed in louver-receiving region 110 while making a flange for receiving gasket 140 (FIG. 3).

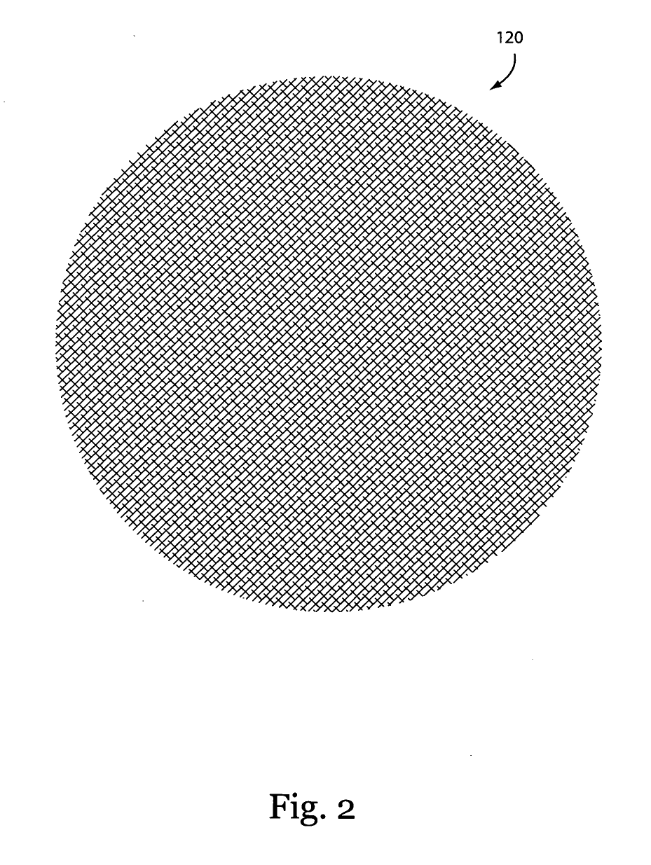

Referring now to FIG. 2, there is shown a top plan view of a porous membrane, generally at reference number 120. Membrane 120 is typically formed from polypropylene, which has been found to work satisfactorily in the intended application within water-excluding vent 100 (FIG. 1). A 12 mil thick woven polypropylene fabric having a plain weave and weighing 4.5 ounces per square yard (in accordance with ASTM D 5261) material from The Dize Company has been found satisfactory for the application. It will be recognized that membrane 120 may alternately be formed from other polymeric or metallic materials and the invention is not limited to polypropylene material used for purposes of disclosure.

Referring now to FIG. 3, there is shown, a top plan view of a perimeter gasket, generally at reference number 140. Perimeter gasket 140 is formed from a thin, resilient material such as foam rubber, silicone or cork. It will be recognized that many similar thin, resilient materials are known in the art, which may be interchanged with those described herein. The invention is not limited to foam rubber used for purposes of disclosure. Perimeter gasket has an outer edge 144 and an inner edge 148. A series of notches 142 may be formed in an outer edge 144 as required to align with mounting holes 106 (FIG. 1).

A single notch 146 is disposed in inner edge 148 of perimeter gasket 140. Notch 146 is disposed and adapted so that a space defined by notch 146 is aligned with drain hole 108 (FIG. 1). Consequently, in operation, notch 146 will also be disposed at the lowermost point of water-excluding vent 100 (FIG. 1).

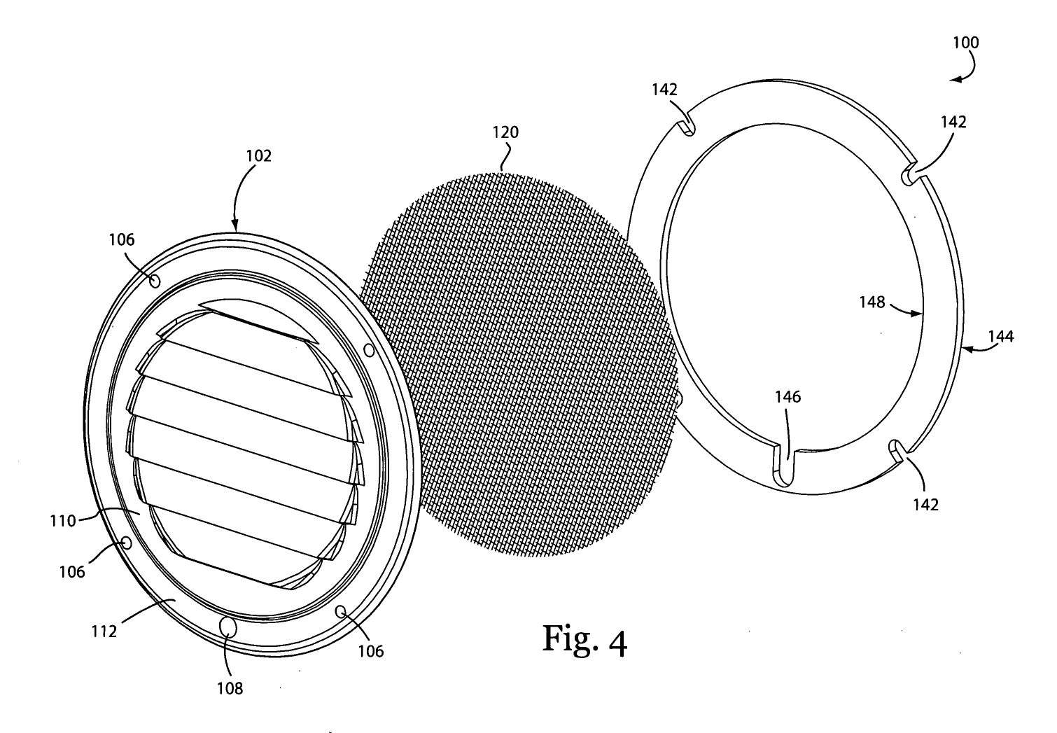

Referring now to FIG. 4, there is shown an exploded, perspective view of the component arrangement of the water-excluding vent 100 of the present invention. As may be clearly seen, membrane 120 is disposed at the rear surface of outer housing 102 at the rear side of louvers 104. Membrane 120 covers at least central, louver-receiving region 110. Perimeter gasket 144 is secured to the rear surface of perimeter region 112 (FIG. 1) or outer housing 102 (FIG. 1) using any suitable adhesive, not shown. Suitable adhesives are believed to be known to those of skill in the art and are not further described herein. Notches 142 in gasket 144 are aligned with mounting holes 106 (FIG. 1).

In operation, water-excluding vent assembly 100 is disposed in an orientation wherein louvers 104 are substantially horizontal. In such an orientation, orifice (i.e., drain hole) 108 is disposed at the lowermost point in outer housing 102. Any moisture passing through louvers 104 and membrane 120 collects on an inner surface of membrane 120. The moisture is gravitationally attracted such that droplets roll down the inner surface of membrane 120 and finally collect in a space defined by notch 146. Moisture accumulating in the space defined by notch 146 is discharged from vent assembly 100 via orifice 108.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A water-excluding vent assembly, comprising:
a) a substantially planar outer housing having a front surface and an inner surface substantially parallel thereto;
b) at least one elongated louver disposed in a central, louver-receiving region of said outer housing allowing fluid communication between said front surface and said rear surface;
c) a porous membrane having a front surface and a rear surface, said front surface of said porous membrane being disposed on said rear surface of said outer housing adjacent a rear side of said at least one louver;
d) a substantially planar perimeter gasket disposed adjacent said rear surface of said porous membrane and along an entire perimeter of said inner surface of said outer housing in a region surrounding said at least one elongated louver, said perimeter gasket having an outer perimeter edge and an inner perimeter edge; and
e) a notch in said inner perimeter edge disposed on an orthogonal line substantially bisecting said at least one elongated louver; and
f) an orifice in said outer housing communicative with a space defined by said notch.

2. The water-excluding vent assembly as recited in claim 1, wherein said outer housing is substantially circular.

3. The water-excluding vent assembly as recited in claim 2, wherein said substantially outer housing comprises a perimeter region devoid of louvers and a central region containing said at least one elongated louver enclosed by said perimeter region.

4. The water-excluding vent assembly as recited in claim 3, further comprising:
g) at least one mounting hole disposed in said perimeter region of said outer housing.

5. The water-excluding vent assembly as recited in claim 3, wherein said at least one elongated louver comprises a plurality of substantially parallel elongated louvers disposed in said central region of said outer housing.

6. The water-excluding vent assembly as recited in claim 3, wherein said perimeter gasket comprises a resilient polymer selected to prevent fluid flow therethrough, said perimeter gasket being disposed exclusively in said perimeter region of said outer housing.

7. The water-excluding vent assembly as recited in claim 1, wherein said membrane comprises a polypropylene membrane.

8. The water-excluding vent assembly as recited in claim 1, wherein said central, louver-receiving region of said outer housing is offset from said perimeter region thereof along a line substantially perpendicular to both said outer surface and said inner surface of said outer housing.

9. A water-excluding vent assembly comprising:
a) a substantially circular or other appropriate shapes, substantially planar outer housing having a front surface and an inner surface substantially parallel thereto, said outer housing comprising a outer, perimeter region surrounding a central, louver-receiving region;
b) a plurality of elongated, substantially parallel louvers disposed in said central, louver-receiving region of said outer housing, said plurality of elongated, substantially parallel louvers being disposed and configured to allow fluid communication between said front surface and said rear surface of said outer housing;
c) a porous polypropylene membrane having a front surface and a rear surface, said front surface of said porous membrane being disposed on said rear surface of said outer housing in said central region and adjacent a rear side of said plurality of elongated, substantially parallel louvers;
d) a substantially circular or other appropriate shapes, planar perimeter gasket having an inner edge and an outer edge disposed adjacent said rear surface of said porous membrane in said perimeter region of said inner surface of said outer housing;
e) a notch in said inner edge disposed on an orthogonal line substantially bisecting said plurality of elongated, substantially parallel louvers; and
f) an orifice in said outer housing communicative with a space in said perimeter gasket defined by said notch.

10. The water-excluding vent assembly as recited in claim 9, further comprising:
g) at least one mounting hole disposed in said perimeter region of said outer housing.

11. The water-excluding vent assembly as recited in claim 9, wherein said central region of said outer housing is offset from said perimeter region thereof along a line substantially perpendicular to both said outer surface and said inner surface of said outer housing.
